(19) United States
(12) Patent Application Publication
(10) Pub. No.: US 2025/0309586 A1
(43) Pub. Date: Oct. 2, 2025

(54) BODY WORN CAMERA SIDE LATCH

(71) Applicant: Axon Enterprise, Inc., Scottsdale, AZ (US)

(72) Inventors: Zackary T. Hickman, Austin, TX (US); Jonathan R. Hatcher, Daytona Beach, FL (US); John Groff, San Francisco, CA (US); Kenneth Chou, Burnaby (CA)

(21) Appl. No.: 19/098,472

(22) Filed: Apr. 2, 2025

Related U.S. Application Data
(60) Provisional application No. 63/573,307, filed on Apr. 2, 2024.

(51) Int. Cl. H01R 13/627

(52) U.S. Cl. CPC H01R 13/6275

(57) ABSTRACT

A locking system comprises a connector, a connector cable that extends from the connector and a connector socket. The connector may comprise a connector slide, one or more latches, and a connector interface. The connector slide may be configured to translate, based at least on one or more user inputs, between a first position and a second position along a first axis. The first position may put the one or more latches in the locked state and the second position may put the one or more latches in the unlocked state. The one or more latches and the connector interface extend from a bottom surface of the connector along a second axis perpendicular to the first axis. Translation of the connector slide may apply a rotational force to the one or more latches via one or more latch pins associated with the one or more latches.

### CROSS-REFERENCE TO RELATED APPLICATIONS

This application claims the benefit of U.S. Provisional Patent Application 63/573,307 filed Apr. 2, 2024, which is incorporated by reference herein in entirety.

### FIELD OF THE INVENTION

Embodiments of the present disclosure relate to a mount.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the detailed description and claims when considered in connection with the following illustrative figures. In the following figures, like reference numbers refer to similar elements and steps throughout the figures.

FIG. 1 is a perspective view of a connector that couples with an accessory, in accordance with various embodiments;

FIG. 2 is a perspective view of internal component (a) of a connector, in accordance with various embodiments;

FIG. 3 is a bottom perspective view of a connector, in accordance with various embodiments;

FIG. 4A is a perspective view of operable components of a connector in a first state, in accordance with various embodiments;

FIG. 4B is a perspective view of operable components of a connector in a second state, in accordance with various embodiments;

FIG. 5A is a perspective view of a connector and a connector socket, in accordance with various embodiments; and

FIG. 5B is a perspective view of a connector coupled with a connector socket, in accordance with various embodiments.

Elements and steps in the figures are illustrated for simplicity and clarity and have not necessarily been rendered according to any particular sequence. For example, steps that may be performed concurrently, in different order, or omitted are illustrated in the figures to help to improve understanding of embodiments of the present disclosure.

### DETAILED DESCRIPTION

The detailed description of exemplary embodiments herein makes reference to the accompanying drawings, which show exemplary embodiments by way of illustration. While these embodiments are described in sufficient detail to enable those skilled in the art to practice the disclosures, it should be understood that other embodiments may be realized and that logical changes and adaptations in design and construction may be made in accordance with this disclosure and the teachings herein. Thus, the detailed description herein is presented for purposes of illustration only and not of limitation.

The scope of the disclosure is defined by the appended claims and their legal equivalents rather than by merely the examples described. For example, the steps recited in any of the method or process descriptions may be executed in any order and are not necessarily limited to the order presented. In some embodiments, one or more steps recited in any of the method or process descriptions may be omitted. Any reference herein to singular includes plural embodiments, and any reference to more than one component or step may include a singular embodiment or step. Reference to attached, fixed, coupled, connected, or the like may include permanent, removable, temporary, partial, full, and/or any other possible attachment option. Surface shading lines may be used throughout the figures to denote different parts but not necessarily to denote the same or different materials.

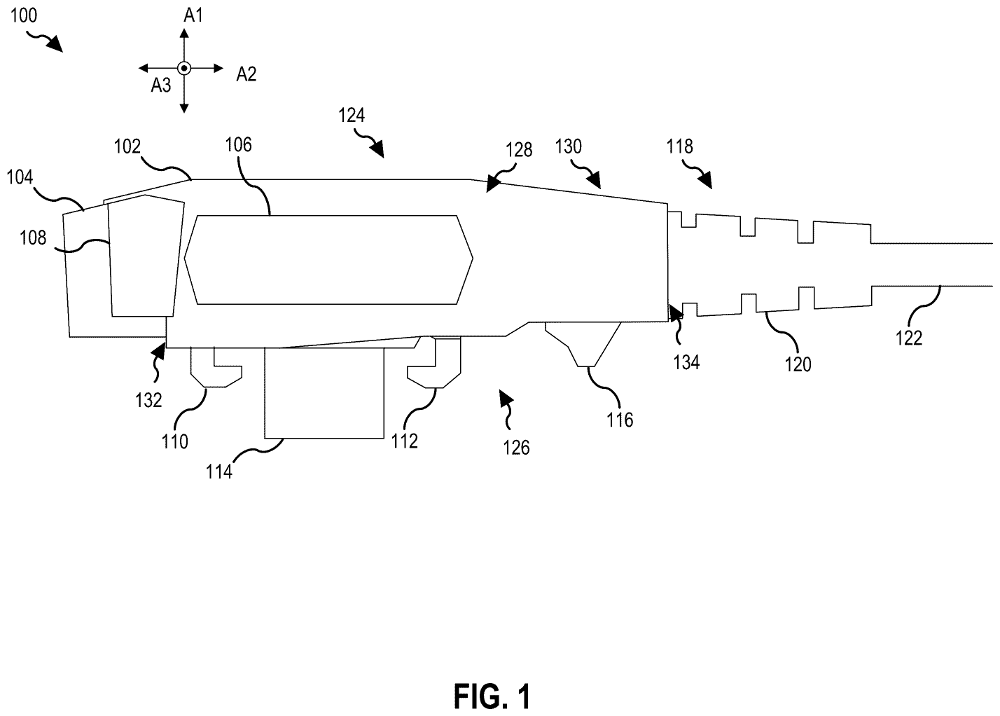

In various embodiments, and with reference to FIG. 1, a connector 100 is disclosed. Connector 100 may be configured to couple a cable with a body worn camera such that power, data, indications, and/or other information may be exchanged with the body worn camera. It should be noted that while connector 100 will be discussed with reference to a body worn camera, connector 100 may be configured to couple with other cameras, computers, personal devices (e.g., mobile phones, tablets, laptops, etc.), and/or other devices. Generally, connector 100 may be utilized to couple a cable with an accessory such that power and/or information may be exchanged with the accessory. As noted above, the accessory may comprise a camera configured to record video and/or audio. The camera may comprise any suitable recording device, camera, microphone, or the like, such as a fixed camera, a rotating camera, a body-worn camera, a point-of-view (POV) camera, and/or the like. As a further example, the accessory may comprise a projectile launcher configured to launch one or more projectiles towards a target. The projectile launcher may comprise a conducted electrical weapon (CEW), a modular conducted electrical weapon (MCEW), a payload launcher, a projectile device configured to deploy entangling projectiles, a paintball gun, a visual marking device, and/or the like.

In various embodiments, connector 100 may comprise any suitable material. One or more components of connector 100 may be formed of one or more rigid, durable materials able to withstand force(s) applied to connector 100 during use. For example, one or more components of connector 100 may include one or more rigid, plastic materials, metal materials, and/or composite materials. The one or more rigid materials may include corrosion-resistant materials, UV resistant materials, and/or any other suitable material configured to at least partially withstand environmental factors. Rigid materials may include metals and metallic alloys (e.g., aluminum, steel, titanium, etc.), composites (e.g., fiberglass, carbon fiber, etc.), plastics (e.g., polycarbonate, acrylonitrile butadiene styrene, polyether ether ketone, etc.), and/or the like. The rigid materials may also be treated (e.g., heat-treated, galvanized, anodized, etc.), painted (e.g., powder-coated, e-coated, etc.), and/or coated or modified to aid in withstanding environmental factors.

In various embodiments, connector 100 may comprise a connector housing 102. Connector housing 102 may be associated with a latch housing 104. Connector housing 102 may comprise a connector grip 106 and latch housing 104 may comprise a latch grip 108. Additionally, connector 100 may comprise a first latch 110, a second latch 112, and a connector interface 114. Further, connector 100 may comprise a cable interface 118, a cable protector 120, and a cable 122.

In various embodiments, connector housing 102 may comprise a top surface 124 opposite a bottom surface 126. Similarly, connector housing 102 may comprise a first side surface 128 (e.g., a left side surface) opposite a second side surface 130 (e.g., a right side surface). Further, connector housing 102 may comprise a front surface 132 (e.g., a forward surface, a third side surface, etc.) opposite a rear surface 134 (e.g., a rearward surface, a fourth side surface, etc.). Latch housing 104 may be disposed proximate to and/or in association with front surface 132. Connector grip 106 may be disposed on at least one of top surface 124, first side surface 128, and/or second side surface 130. First latch 110, second latch 112, and connector interface 114 may be disposed proximate to and/or in association with bottom surface 126. Cable interface 118 may be disposed proximate to and/or in association with rear surface 132 such that cable 122 extends from rear surface 132. A first axis A1 may extend between and through top surface 124 and bottom surface 126. A second axis A2 may extend between and through front surface 132 and rear surface 134. A third axis A3 may extend between and through first side surface 128 and second side surface 130.

In various embodiments, one or more internal mechanisms of connector 100 may be associated with connector housing 102 and/or latch housing 104. In particular, latch housing 104 may be utilized by a user of connector 100 to manipulate the one or more internal mechanisms. For example, latch housing 104 may be translated along second axis A2 such that latch housing 104 is distanced from front surface 132 of connector housing 102. Translation of latch housing 104 along second axis A2 may manipulate the one or more internal mechanisms, activate the one or more internal mechanisms, and/or otherwise switch the one or more internal mechanisms between one or more states. Additionally, latch housing 104 may be configured to start in, return to, and/or otherwise be disposed in a first position in a first time. While in the first position, latch housing 104 may couple connector 100 to an accessory (e.g., a body worn camera, a user device, etc.). Further, latch housing 104 may be translated from the first position to a second position by a user of connector 100. Translation of latch housing 104 from the first position to the second position may decouple, disconnect, release, and/or otherwise enable connector 100 to be disassociated from the accessory. Similarly, translation of latch housing 104 from the second position to the first position may couple, connect, secure, and/or otherwise associate connector 100 with the accessory. Alternatively, or in addition, translation of latch housing 104 from the second position to the first position may return latch housing 104 and connector 100 to a default state independent of connector 100 being associated with the accessory.

In various embodiments, connector 100 may be configured to couple with and decouple from an accessory. In particular, connector 100 may comprise at least a first latch 110 and a second latch 112 that removably secure connector 100 to the accessory. First latch 110 and second latch 112 may be configured to couple and decouple connector 100 to the accessory. For example, first latch 110 and second latch may be disposed along the second axis A2. First latch 110 may be disposed between a front end of connector housing 102 (e.g., a first end of connector housing 102 on the second axis A2 associated with front surface 132 and latch housing 104) and connector interface 114. Similarly, second latch 112 may be disposed between a rear end of connector housing 102 (e.g., a second end of connector housing 102 on the second axis A2 associated with rear surface 132 and cable interface 118). Additionally, first latch 110 and second latch 112 may be associated with a first state (e.g., a locked state, a secured state, a default state, a rest state, etc.) and a second state (e.g., an unlocked state, a released state, an opened state, etc.) of connector 100.

In various embodiments, first latch 110 may be associated with a first axis of rotation and second latch 112 may be associated with a second axis of rotation. In particular, first latch 110 may be configured to rotate from a first position of first latch 110 to a second position of first latch 110, the first position associated with the first state of connector 100 and the second position associated with the second state of connector 100. Similarly, second latch may be configured to rotate from third position of second latch 112 to a fourth position of second latch 112, the third position associated with the first state of connector 100 and the fourth position associated with the second state of connector 100. First latch 110 and second latch 112 may be disposed such that the first axis of rotation is parallel to the second axis of rotation. First latch 110 may be configured to rotate around the first axis of rotation, from the first position proximate to connector interface 114 to the second position removed from connector interface 114. Similarly, second latch 112 may be configured to rotate around the second axis of rotation and opposite the first latch 110, from the third position proximate to connector interface 114 to the fourth position removed from connector interface 114.

In various embodiments, connector interface 114 may be configured to form a connection with an accessory. In particular, connector interface 114 may establish a communication pathway, an electrical circuit, and/or other connection with a connector port of the accessory. Connector interface 114 may be secured in association with the connector port and the accessory by first latch 110 and second latch 112. For example, connector 100 may be transitioned from the first state to the second state to enable association of connector interface 114 with the connector port of the accessory. Additionally, connector 100 may be transitioned from the second state to the first state to secure connector interface 114 in association with the connector port and the accessory. Connector interface 114 may utilize a connector profile associated with various data and/or power connectors. For example, connector interface 114 may be configured as a USB connector, a micro-USB connector, a USB Type-C connector, a SATA connector, an HDMI connector, a DisplayPort connector, a Thunderbolt connector, and/or other connector configuration.

In various embodiments, connector 100 may comprise one or more connector grips 106 and/or one or more connector handles 116. In particular, one or more connector grips 106 may be disposed on at least one of top surface 124, first side surface 128, and/or second side surface 130. Similarly, one or more connector handles 116 may be disposed on at least one of top surface 124, bottom surface 126, first side surface 128, and/or second side surface 130. One or more connector grips and/or one or more connector handles 116 may be configured for ease of handling by a user of connector 100, stabilization of connector 100 while manipulating latch housing 104 between the first state and the second state, and/or ease of insertion for connector interface 114 and the accessory.

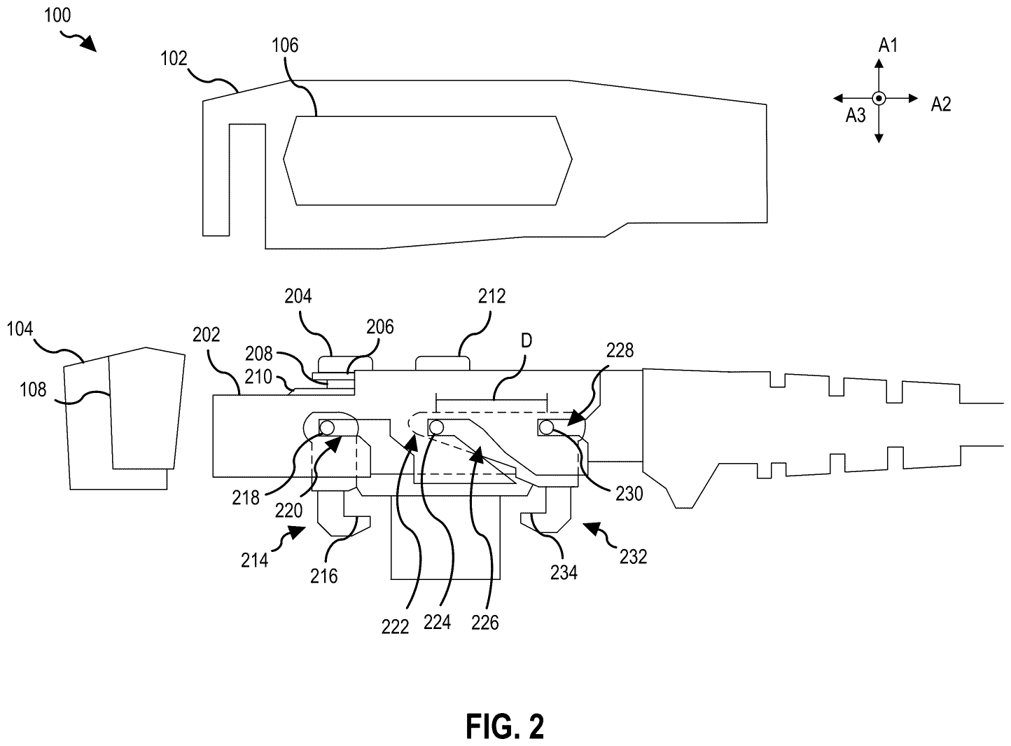

In various embodiments, and with reference to FIG. 2, a connector 100 is disclosed. As previously noted, connector 100 may be configured to couple a cable with an accessory such that power, data, indications, and/or other information may be exchanged with the accessory. Connector 100 may be configured to couple with cameras (e.g., vehicle mounted cameras, body worn cameras, etc.), computers, personal devices (e.g., mobile phones, tablets, laptops, etc.), and/or other devices. Generally, connector 100 may be utilized to couple a cable with an accessory such that power and/or information may be exchanged with the accessory. Connector housing 102 may be configured to contain one or more internal components of connector 100. Latch housing 104 may be configured to enable a user of connector 100 to manipulate the one or more internal components between at least a first state and a second state of connector 100.

In various embodiments, the one or more internal components of connector 100 may comprise one or more stateful components. The one or more internal components of connector 100 may comprise one or more static components. In particular, the one or more internal components may comprise a connector slide 202, a first fastener 204, and an internal connector housing 210. Connector slide 202 may comprise a slide track 206, slide track 206 enabling first fastener 204 and second fastener 212 to secure connector slide 202 to internal connector housing 210. Connector slide 202 may be associated with first latch 214 (e.g., first latch 110) and second latch 232 (e.g., second latch 112), connector slide 202 configured to manipulate first latch 214 and second latch 232 between the first state and the second state.

In various embodiments, the one or more stateful components of connector 100 may comprise connector slide 202, first latch 214, and second latch 232. In particular, the one or more stateful components may be transitioned between at least the first state and the second state by the user. For example, the user may push and pull latch housing 104 along second axis A2 to transition connector slide 202, first latch 214, and second latch 232 between the first state and the second state.

In various embodiments, first latch 214 may comprise a first latch surface 216, and a first latch shaft 218. Similarly, second latch 232 may comprise a second latch surface 234, and a second latch shaft 230. Additionally, second latch 232 may comprise a second latch arm 222 associated with a second latch pin 224. It should be noted that first latch 214 may comprise a first latch arm and a first latch pin similar to second latch 232. Second latch arm 222 may be disposed proximate to a first side surface (e.g., first side surface 128) and first latch arm may be disposed proximate to a second side surface (e.g., second side surface 130). Additionally, second latch arm 222 may extend parallel to the first side surface, along second axis A2, from at least second latch shaft 230. Similarly, first latch arm may extend parallel to the second side surface, along second axis A2, from at least first latch shaft 218. It should be noted that while second latch pin 224, and later depictions of latch pins below, depict a circular cross section (e.g., latch pin being configured as a cylinder), second latch pin 224 may be configured with substantially any cross section suitable for causing transition from a first state of connector 100 to a second state of connector 100. For example, the cross section of second latch pin 224 may be configured as an ellipse, a rounded rectangle, and/or other two dimensional shape that permits movement of second latch pin 224 within second channel 226.

In various embodiments, connector slide 202 may comprise a first channel 220, a second channel 226 and a third channel 228 disposed proximate to the first side surface. Additionally, connector slide 202 may further comprise a fourth channel, a fifth channel, and a sixth channel disposed proximate to the second side surface. First channel 220 may be configured to interact with first latch shaft 218. Second channel 226 may be configured to interact with second latch pin 224. Third channel 228 may be configured to interact with second latch shaft 230. Similarly, fourth channel may interact with first latch shaft 218, fifth channel may interact with the first arm pin, and sixth channel may interact with second latch shaft 230.

In various embodiments, first latch shaft 218 may extend along third axis A3. Additionally, first latch shaft 218 may extend into and/or through internal connector housing 210. Alternatively, or in addition, a first portion of first latch shaft 218 may extend into a first recess of internal connector housing 210 and a second portion of first latch shaft 218 may extend into a second recess of internal connector housing 210. First latch shaft 218 may be a single shaft that extends between the first side surface and the second side surface of internal connector housing 210. Alternatively, first latch shaft 218 may comprise a first latch shaft portion and a second latch shaft portion that extend into internal connector housing 210. Further, first latch shaft 218 may extend from first latch 214 and through first channel 220 of connector slide 202 and fourth channel of connector slide 202.

In various embodiments, second latch shaft 230 may extend along third axis A3. Second latch shaft 230 may extend along third axis A3 parallel to first latch shaft 218. Additionally, second latch shaft 230 may extend into an/or through internal connector housing 210. Alternatively, or in addition, a first portion of second latch shaft 230 may extend into a third recess of internal connector housing 210 and a second portion of second latch shaft 230 may extend into a fourth recess of internal connector housing 210. Second latch shaft 230 may be a single shaft that extends between the first side surface and the second side surface of internal connector housing 210. Alternatively, second latch shaft 230 may comprise a third latch shaft portion and a fourth latch shaft portion that extend partially into internal connector housing 210. Further, second latch shaft 230 may extend from second latch 232 through third channel 228 of connector slide 202 and sixth channel of connector slide 202.

In various embodiments, second latch pin 224 may extend from second latch 232 along third axis A3. Second latch pin 224 may extend along third axis A3 parallel to second latch shaft 230. Additionally, second latch pin 224 may extend from second latch arm 222 through second channel 226. Similarly, first latch pin may extend from first latch 214 from a first latch arm along third axis A3 and parallel to first latch shaft 218. Further, first latch pin may extend from the first latch arm through the fifth channel of connector slide 202.

In various embodiments, second latch pin 224 may extend from second latch arm 222 and interact with connector slide 202 to transition second latch between the first state and the second state. In particular, second latch shaft 230 may provide a rotational axis for second latch 232. Application of an amount of force to second latch pin 224, at least partially along first axis A1, may cause second latch 232 to rotate around second latch shaft 230. Rotation of second latch 232 around second latch shaft 230 may cause second latch surface 234 to be removed from an associated socket of the accessory. For example, applying the amount of force towards the bottom surface of connector 100 may cause second latch 232 to rotate away from a connector interface (e.g., connector interface 114) and towards a rear surface of connector 100 (e.g., rear surface 134). Similarly, applying the amount of force towards the top surface of connector 100 may cause second latch 232 to rotate towards the connector interface. Second latch pin 224 may be separated from second latch shaft 230 by a distance D, distance D configured to provide the amount of force sufficient leverage to rotate second latch 232.

In various embodiments, the first latch pin may be configured similar to second latch pin 224. First latch pin may extend from the first latch arm and interact with connector slide 202 to transition first latch between the first state and the second state. Application of the amount of force to the first latch pin, at least partially along first axis A1, may cause first latch 214 to rotate around first latch shaft 218. Rotation of first latch 214 around first latch shaft 218 may cause first latch surface 216 to be removed from an associated socket of the accessory. For example, applying the amount of force towards the bottom surface of connector 100 may cause first latch 214 to rotate away from a connector interface (e.g., connector interface 114) and towards a front surface of connector 100 (e.g., rear surface 132). Similarly, applying the amount of force towards the top surface of connector 100 may cause first latch 214 to rotate towards the connector interface.

In various embodiments, translation of connector slide 202 may apply the amount of first to the first latch pin and second latch pin 224. In particular, connector slide 202 may be translated, via latch housing 104, towards and/or past the front surface of connector housing 102 (e.g., front surface 132) to transition connector 100 into the second state (e.g., an unlocked state, a released state, etc.). Similarly, connector slide 202 may be translated, via latch housing 104, towards the rear surface of connector housing 102 to transition connector 100 into the first state (e.g., a locked state, a secured state, etc.).

In various embodiments, and as depicted by FIG. 2, first latch 214 and second latch 232 may be configured as asymmetrical latches. In particular, first latch 214 may be configured such that the first latch arm extends along the second side of connector 100 and second latch arm 222 extends along the first side of connector 100. Additionally, first latch 214 may be secured, via first latch shaft 218, to the first side of internal connector housing 210 and the second side of internal connector housing 210. Similarly, second latch 232 may be secured, via second latch shaft 230, to the first side of internal connector housing 210 and the second side of internal connector housing 210. As a result, first latch 214 and second latch 232 may extend along different sides of internal connector housing 210.

In various embodiments, first latch 214 and second latch 232 may be configured as symmetrical latches. In particular, first latch 214 may comprise the first latch arm and/or a third latch arm, wherein the first latch arm extends along the second side of connector 100 and/or the third latch arm extends along the first side of connector 100. Additionally, second latch 232 may comprise second latch arm 222 and/or a fourth latch arm, wherein second latch arm 222 extends along the first side of connector 100 and/or the fourth latch arm extends along the second side of connector 100. Further, first latch 214 may be secured, via first latch shaft 218, to the first side of internal connector housing 210 and the second side of internal connector housing 210. Similarly, second latch 232 may be secured, via second latch shaft 230, to the first side of internal connector housing 210 and the second side of internal connector housing 210. As a result, first latch 214 and second latch 232 may extend along the same side and/or both sides of internal connector housing 210.

In various embodiments, first latch 214 and second latch 232 may be configured as symmetrical latches and/or as asymmetrical latches. Configuring first latch 214 and second latch 232 as symmetrical latches may result in even distribution of the amount of force applied to the first latch pin(s), second latch pin(s) 224, first latch shaft 218, and/or second latch shaft 230. Configuring first latch 214 and second latch 232 as asymmetrical latches may result in distance D for the first latch arm and second latch arm 222 to be greater than that of symmetrical latches and permit greater leverages for rotating first latch 214 and second latch 232.

In various embodiments, and with reference to FIG. 2, connector 100 may comprise a connector slide 202. Connector slide 202 may comprise a top slide surface and a bottom slide surface opposite the top slide surface, first axis A1 extending between the top slide surface and the bottom slide surface. Similarly, connector slide 202 may comprise a first slide side surface (e.g., a left side surface) and a second slide side surface (e.g., a right side surface) opposite the first slide side surface, second axis A1 extending between the first slide side surface and the second slide side surface. Further, connector slide 202 may comprise a front slide surface (e.g., a forward surface, a third side surface, etc.) and a rear slide surface (e.g., a rearward surface, a fourth side surface, etc.) opposite the front slide surface, third axis A3 extending between the front slide surface and the rear slide surface. Latch housing 104 may be coupled to, secured to, and/or otherwise attached to the front slide surface.

In various embodiments, and with reference to FIG. 2, connector 100 may comprise internal connector housing 210. Internal connector housing 210 may comprise a top internal surface and a bottom internal surface opposite the top internal surface, first axis A1 extending between the top internal surface and the bottom internal surface. Similarly, internal connector housing 210 may comprise a first internal side surface (e.g., a left side surface) and a second internal side surface (e.g., a right side surface) opposite the first internal side surface, second axis A1 extending between the first internal side surface and the second internal side surface. Further, internal connector housing 210 may comprise a front internal surface (e.g., a forward surface, a third side surface, etc.) and a rear internal surface (e.g., a rearward surface, a fourth side surface, etc.) opposite the front internal surface, third axis A3 extending between the front internal surface and the rear internal surface.

In various embodiments, connector slide 202 may be associated with internal connector housing 210. In particular, connector slide 202 may be secured to internal connector housing 210 by first fastener 204 and second fastener 212. For example, slide track 206 may be an opening in the top slide surface that permits one or more fastener posts 208 to extend through the top slide surface and couple to the top internal surface (e.g., a bolt extends through slide track 206 and screws into a bolt hole in the top internal surface). Slide track 206 may permit translation of connector slide 202 along second axis A2. For example, slide track 206 may be configured as a slot that permits translation of connector slide 202 such that first fastener 204 and second fastener 212 translate between proximity with a first end of slide track 206 to proximity with a second end of slide track 206.

In various embodiments, connector slide 202 may be disposed proximate to internal connector housing 210. In particular, connector slide 202 may comprise a top slide plate, a first slide side plate, and a second slide side plate. The top slide plate may comprise slide track 206. The first slide side plate may be attached to the top slide plate and define the first slide side surface. The second slide side plate may be attached to the top slide plate and define the second slide side surface. Connector slide 202 may be disposed around internal connector housing 210 such that, relative to a center point of internal connector housing 210, the top slide plate is disposed along first axis A1 outward from the top internal surface of internal connector housing 210. Similarly, connector slide may be disposed around internal connector housing 210 such that, relative to the center point of internal connector housing 210, the first slide side plate is disposed along third axis A3 outward from the first internal side surface and the second slide side plate is disposed along third axis A3 outward from the second internal side surface. The center point may reference a point between the top internal surface and the bottom internal surface along first axis A1. The center point may reference a point between the front internal surface and the rear internal surface along second axis A2. The center point may reference a point between the first internal side surface and the second internal side surface along third axis A3.

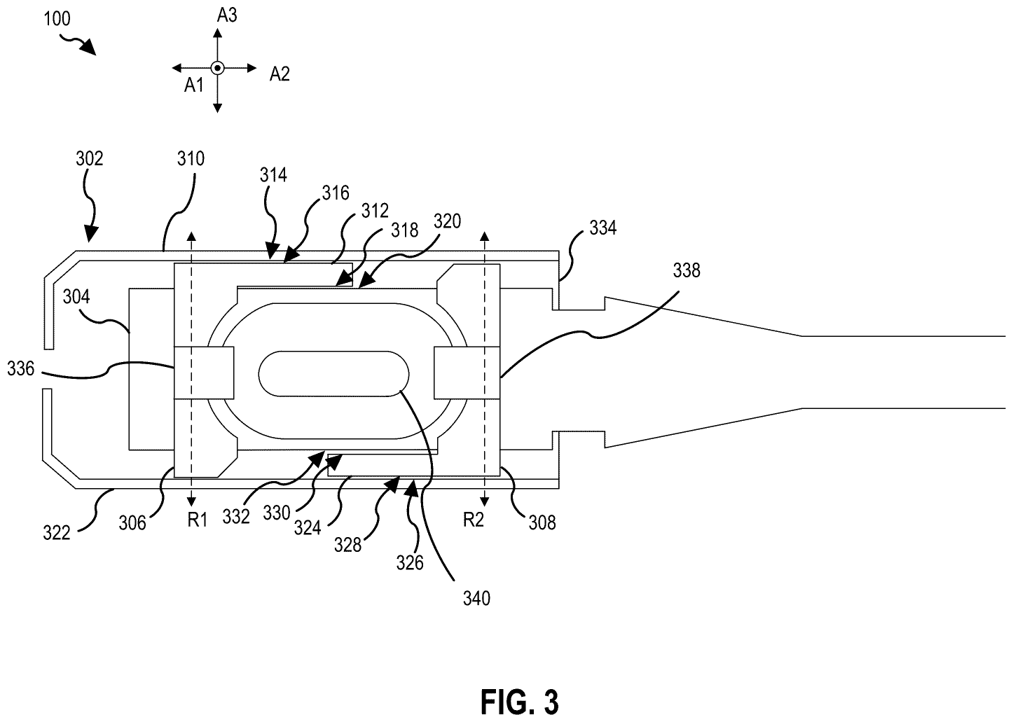

In various embodiments, and with reference to FIG. 3, a connector 300 (e.g., connector 100) is disclosed. As previously noted, the connector may be configured to switch between a locked and an unlocked state to couple a cable with an accessory such that power, data, indications, and/or other information may be exchanged with the accessory. The connector may be configured to couple with cameras (e.g., vehicle mounted cameras, body worn cameras, etc.), computers, personal devices (e.g., mobile phones, tablets, laptops, etc.), and/or other devices. Generally, the connector may be utilized to couple a cable with an accessory such that power and/or information may be exchanged with the accessory. The connector may comprise a latch housing to enable a user of the connector to manipulate one or more internal components between at least the locked state and the unlocked state.

In various embodiments, connector 300 may be configured to such that a first latch 306 is disposed proximate to a connector slide 302 and a connector housing 304. In particular, first latch 306 may be disposed within connector slide 302 and outside connector housing 304. Additionally, connector slide 302 may comprise a first connector side plate 310 and first latch 306 may comprise a first latch arm 312. First latch arm 312 may extend between first connector side plate 310 and connector housing 304. For example, first latch arm 312 may be disposed such that a first side plate inner surface 314 is outward relative to a first latch arm outer surface 316. Further, first latch arm 312 may be disposed such that a first latch arm inner surface 318 is outward relative to a first connector housing side surface 320.

In various embodiments, connector 300 may be configured to such that a second latch 308 is disposed proximate to connector slide 302 and connector housing 304. In particular, second latch 308 may be disposed within connector slide 302 and outside connector housing 304. Second latch 308 may be disposed opposite first latch 306 relative to connector housing 304 along second axis A2 and third axis A3. Additionally, connector slide 302 may comprise a second connector side plate 322 and second latch 308 may comprise a second latch arm 324. Second latch arm 324 may extend between second connector side plate 322 and connector housing 304. For example, second latch arm 324 may be disposed such that a second side plate inner surface 326 is outward relative to a second latch arm outer surface 328. Further, second latch arm 324 may be disposed such that a second latch arm inner surface 330 is outward relative to a second connector housing side surface 332.

In various embodiments, connector slide 302 may be disposed outward relative to connector housing 304. As noted above, first connector slide plate 310 may be disposed such that first side plate inner surface 314 is outside of first connector housing side surface 320 along at least third axis A3. Similarly, second connector slide plate 322 may be disposed such that second side plate inner surface 326 is outside second connector housing side surface 332 along at least third axis A3. First connector slide plate 310 may be disposed opposite second connector slide plate 322. Additionally, first connector slide plate 310 may be connected to second connector slide plate 322 via top connector slide plate 334. Top connector slide plate 334 may be disposed outside a connector housing top surface along first axis A1.

In various embodiments, first latch 306 may rotate around first rotation axis R1 between at least a first state and a second state. As noted above, first latch 306 may transition between at least the first state (e.g., locked state, secured state, rest state, default state, etc.) and the second state (e.g., unlocked state, released state, activated state, etc.) in response to a user input. In particular, the user input may be received via a latch housing (e.g., latch housing 104) coupled to first connector slide plate 310 and/or second connector slide plate 322. The user input may translate connector slide 302 along second axis A2. First connector slide plate 310 may be associated with first latch 306 such that the user input manipulates first latch 306 via first connector slide plate 310.

In various embodiments, second latch 308 may rotate around second rotation axis R2 between at least the first state and the second state. As noted above, and similar to first latch 306, second latch 308 may transition between at least the first state (e.g., locked state, secured state, rest state, default state, etc.) and the second state (e.g., unlocked state, released state, activated state, etc.) in response to the user input. In particular, the user input may be received via the latch housing, the latch housing coupled to first connector slide plate 310 and/or second connector slide plate 322. The user input may translate connector slide 302 along second axis A2. Second connector slide plate 322 may be associated with second latch 308 such that the user input manipulates second latch 308 via second connector slide plate 322.

In various embodiments, first latch 306 may extend around at least a portion of connector housing 304. In particular, first latch 306 may extend along at least a portion of first connector housing side surface 320 parallel to first axis A1 and second axis A2. Additionally, first latch 306 may extend from outside of first connector housing side surface 320, under a bottom connector housing surface, and along second connector housing side surface 332. First latch 306 may extend along at least the second axis and third axis under the bottom connector housing surface. First latch 306 may extend along at least first axis A1 and second axis A2 in proximity to second connector housing side surface 332. Further, first latch 306 may extend between a front connector housing surface and connector interface 340.

In various embodiments, second latch 308 may extend around at least a portion of connector housing 304. In particular, second latch 308 may extend along at least a portion of first connector housing side surface 320 parallel to first axis A1 and second axis A2. Additionally, second latch 308 may extend from outside of first connector housing side surface 320, under a bottom connector housing surface, and along second connector housing side surface 332. Second latch 308 may extend along at least the second axis and third axis under the bottom connector housing surface. Second latch 308 may extend along at least first axis A1 and second axis A2 in proximity to second connector housing side surface 332. Further, second latch 308 may extend between a rear connector housing surface and connector interface 340, the rear connector housing surface opposite the front connector housing surface.

In various embodiments, a first latch hook 336 may extend from first latch 306. Similarly, a second latch hook 338 may extend from second latch 308. In particular, first latch hook 336 and second latch hook 338 may extend from first latch 306 and second latch 308, respectively, opposite from the bottom connector housing surface and parallel to connector interface 340. As depicted by FIGS. 1 and 2, first latch hook 336 may extend from first latch 306 to a contact surface (e.g., first latch surface 216) that extends towards connector interface 340. Similarly, second latch hook 338 may extend from second latch 308 to an additional contact surface (e.g., second latch surface 234) that extends towards connector interface 340 and/or the first latch hook 336. First latch hook 336 and second latch hook 338 may secure connector interface 340 in association with a connector socket of an accessory via one or more latch sockets. For example, connector interface 340 may be inserted within the connector socket while first latch 306 and second latch 308 are in the unlocked state. Transitioning first latch 306 and second latch 308 to the locked state may insert first latch hook 336 and second latch hook 338 within one or more latch sockets, securing connector interface within the connector socket. It should be noted that first latch 306 and second latch 308 may comprise any number of latch hooks that secure connector interface 340 to the accessory and/or the connector socket.

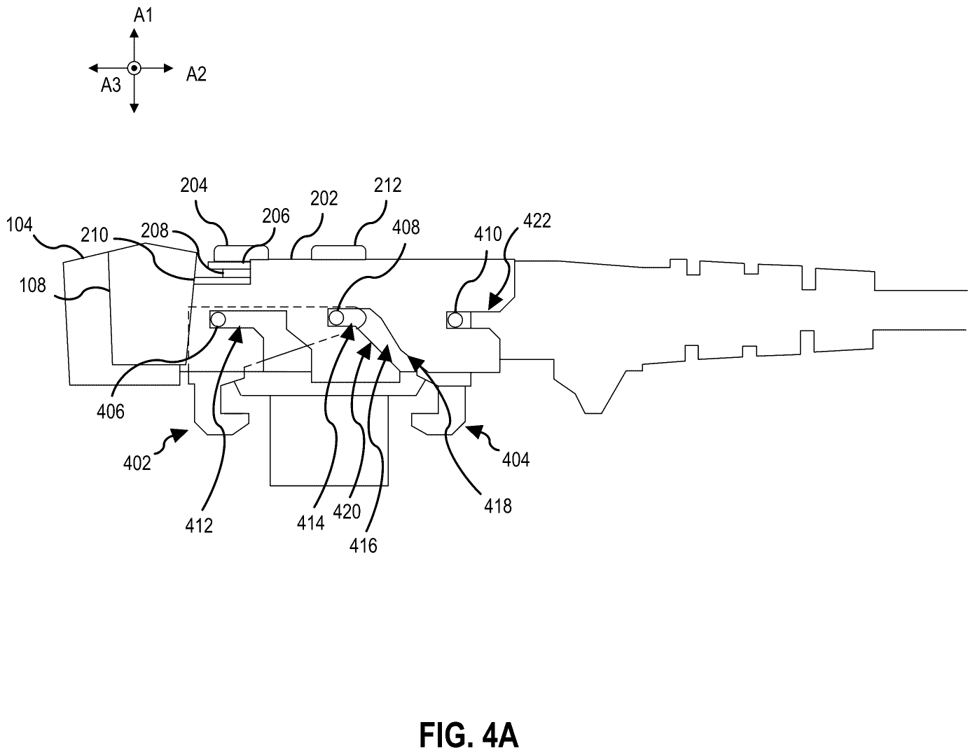

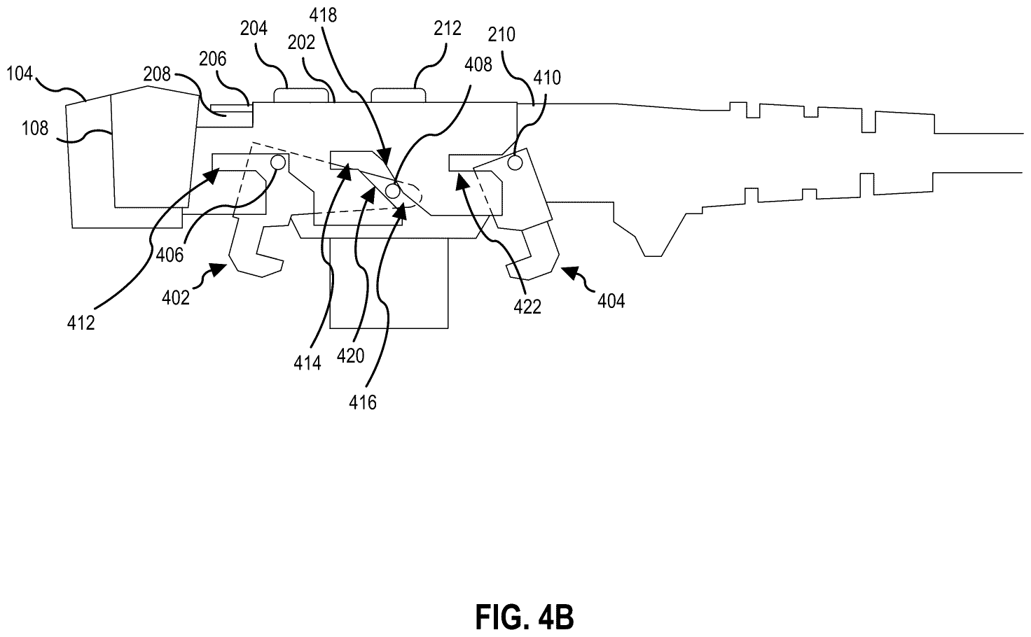

In various embodiments, and with reference to FIGS. 4A and 4B, a connector (e.g., connector 100) is disclosed. As previously noted, the connector may be configured to switch between a locked and an unlocked state to couple a cable with an accessory such that power, data, indications, and/or other information may be exchanged with the accessory. The connector may be configured to couple with cameras (e.g., vehicle mounted cameras, body worn cameras, etc.), computers, personal devices (e.g., mobile phones, tablets, laptops, etc.), and/or other devices. Generally, the connector may be utilized to couple a cable with an accessory such that power and/or information may be exchanged with the accessory. The connector may comprise latch housing 104 to enable a user of the connector to manipulate one or more internal components between at least the locked state and the unlocked state.

In various embodiments, and with reference to FIG. 4A, the connector may be associated with the locked state. In particular, the locked state may be a first state of the connector that is associated with the connector being secured in association with an accessory. Alternatively, or in addition, the locked state may be a first state of the connector that is associated with a rest state, a default state, and/or other state that the connector returns to when the amount of force is not applied to the connector. For example, a bias spring may be associated with internal connector housing 210 and/or connector slide 202 that returns connector slide to the locked state when a user releases latch housing 104. Alternatively, or in addition, connector slide 202 may be configured to remain in the locked state and/or the unlocked state when the user releases latch housing 104, the connector slide 202 transitioning between the locked state and the unlocked state in response to the user interacting with latch housing 104.

In various embodiments, and with reference to FIG. 4B, the connector may be associated with the unlocked state. In particular, the unlocked state may be a second state of the connector that is associated with the connector being released from the accessory. While in the unlocked state, the user of the connector may insert a connector interface within a connector port of the accessory, remove the connector interface from the connector port of the accessory, and/or otherwise manipulate the connector in relation to the accessory and/or other device (e.g., the connector may be attached to a point on an article of clothing when the accessory is being removed from the user).

In various embodiments, the connector may comprise a first latch 402 and a second latch 404. First latch 402 may comprise a first latch shaft 406 and a first latch pin 408. Similarly, second latch 404 may comprise a second latch shaft 410. First latch shaft 406 may be disposed in a first shaft position, depicted by FIG. 4A, within a first channel 412 of connector slide 202 at a first time and in the first state. First latch shaft 406 may be disposed in a second shaft position, depicted by FIG. 4B, within first channel 412 of connector slide 202 at a second time and in the second state. First latch shaft 406 may remain static relative to internal connector housing 210 relative to at least second axis A2. First latch shaft 406 may rotate within internal connector housing 210 between the first time and the second time. Connector slide 202 may translate relative to first latch shaft 406 and connector housing 210 along second axis A2. Translation of connector slide 202 may translate first latch shaft 406 from the first position at the first time to the second position at the second time.

In various embodiments, first latch pin 408 may transition first latch 402 between the first state and the second state. First latch pin 408 may be disposed in a first pin position, depicted by FIG. 4A, within a second channel 414 of connector slide 202 at the first time and in the first state. First latch pin 408 may be disposed in a second pin position, depicted by FIG. 4B, within second channel 414 of connector slide 202 at the second time and in the second state. Second channel 414 may comprise a pin track 416 configured to apply an amount of force to first latch pin 408 during translation of connector slide 202 by a user input.

In various embodiments, a first user input may transition the connector from the first state to the second state. As noted above, first latch pin 408 may be disposed in the first pin position and first latch shaft 406 in the first latch position. The first user input may translate connector slide 202 in a first direction along second axis A2 relative to internal connector housing 210 (e.g., to the left in FIGS. 4A and 4B, away from the rear surface of the connector, towards the front surface of the connector, etc.). Translation of connector slide 202 by the first user input may cause first latch shaft 406 to translate from the first shaft position to the second shaft position relative to connector slide 202. Additionally, translation of connector slide 202 by the first user input may cause first latch pin 408 to translate from the first pin position and contact first channel surface 418. Contact between first latch pin 408 and first channel surface 418 may apply the amount of force to first latch 402 via first latch pin 408 during the first user input. Continued translation of connector slide 202 may cause first latch pin 408 to traverse first channel surface 418 and may cause first latch 402 to rotate around first latch shaft 406. Upon causing first latch pin 408 to reach the second pin position, depicted by FIG. 4B, the first user input may place first latch in the second state.

In various embodiments, a second user input may transition the connector from the second state to the first state. First latch pin 408 may be disposed in the second pin position and first latch shaft 406 in the second latch position. The second user input may translate connector slide 202 in a second direction along second axis A2 relative to internal connector housing 210 (e.g., to the right in FIGS. 4A and 4B, towards from the rear surface of the connector, away from the front surface of the connector, etc.). Translation of connector slide 202 by the second user input may cause first latch shaft 406 to translate from the second shaft position to the first shaft position relative to connector slide 202. Additionally, translation of connector slide 202 by the second user input may cause first latch pin 408 to translate from the second pin position and contact second channel surface 420. Contact between first latch pin 408 and first channel surface 418 may apply the amount of force to first latch 402 via first latch pin 408 during the second user input. Continued translation of connector slide 202 may cause first latch pin 408 to traverse second channel surface 420 and may cause first latch 402 to rotate around first latch shaft 406. Upon causing first latch pin 408 to reach the first pin position, depicted by FIG. 4A, the second user input may place first latch in the first state.

In various embodiments, second channel 414 may be configured to enable transition of connector between the first state and the second state. In particular, first channel surface 418 and second channel surface 420 of second channel 414 may cause first latch 402 to rotate around first latch shaft 406. Additionally, and in response to the first user input and/or the second user input, first channel surface 418 and second channel surface 420 may enable a user to apply the amount of force that causes first latch 402 to engage with and disengage from an accessory socket. Engaging first latch 402 (e.g., putting the connector in the first state) may secure the connector in association with the accessory. Disengaging first latch (e.g., putting the connector in the second state) may permit the connector to release the accessory and be removed from association with the accessory. For example, the first user input applies the amount of force to first latch pin 408 via first channel surface 418, a magnitude of the amount of force modified by a first slope of the first channel surface 418. The amount of force may be sufficient to overcome resistance that maintains association between first latch 402 and the accessory (e.g., friction, contact between one or more surfaces of first latch 402 and the accessory, one or more bias springs, etc.) and remove first latch from the accessory. Similarly, the second user input applies the amount of force to first latch pin 408 via second channel surface 420, an additional magnitude of the amount of force modified by a second slide of the second channel surface 420. The amount of force may be sufficient to overcome resistance to association of first latch and the accessory (e.g., friction, contact between one or more surfaces of first latch 402 and the accessory, misalignment of the connector and accessory that is corrected by engaging first latch 402 and the accessory, etc.).

In various embodiments, second latch 404 may be configured to transition between the first state and the second state. Second latch shaft 410 may be disposed in a third shaft position, depicted by FIG. 4A, within a third channel 422 of connector slide 202 at the first time and in the first state. Second latch shaft 410 may be disposed in fourth shaft position, depicted by FIG. 4B, within third channel 422 of connector slide 202 at the second time and in the second state. Second latch shaft 410 may remain static relative to internal connector housing 210 and relative to at least second axis A2. Second latch shaft 410 may rotate within internal connector housing 210 between the first time and the second time. Connector slide 202 may translate relative to second latch shaft 410 and connector housing 210 along second axis A2. Translation of connector slide 202 may translate second latch shaft 410 from the first position at the first time to the second position at the second time.

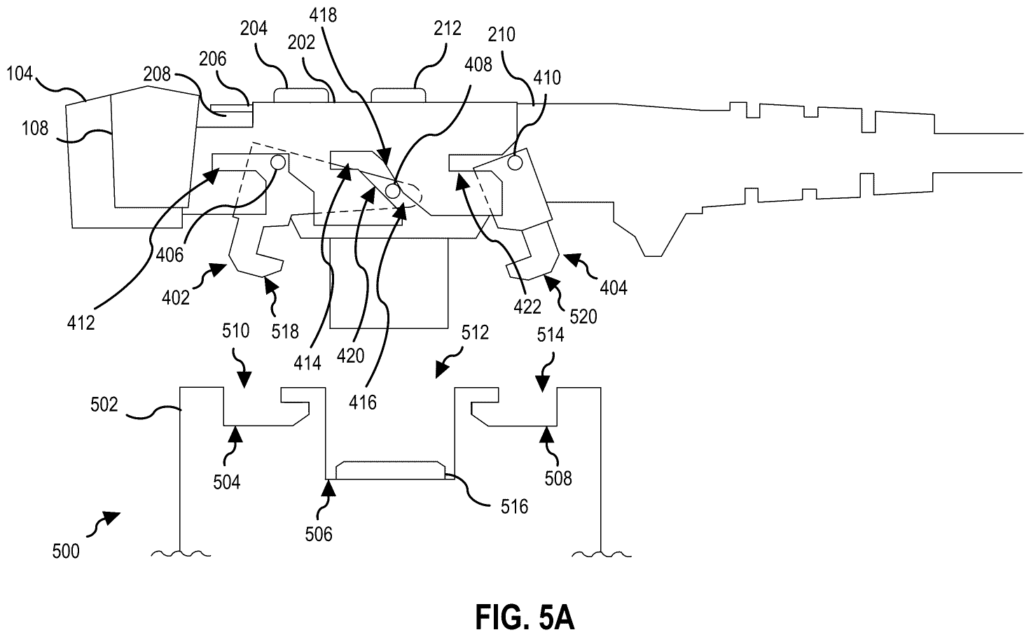

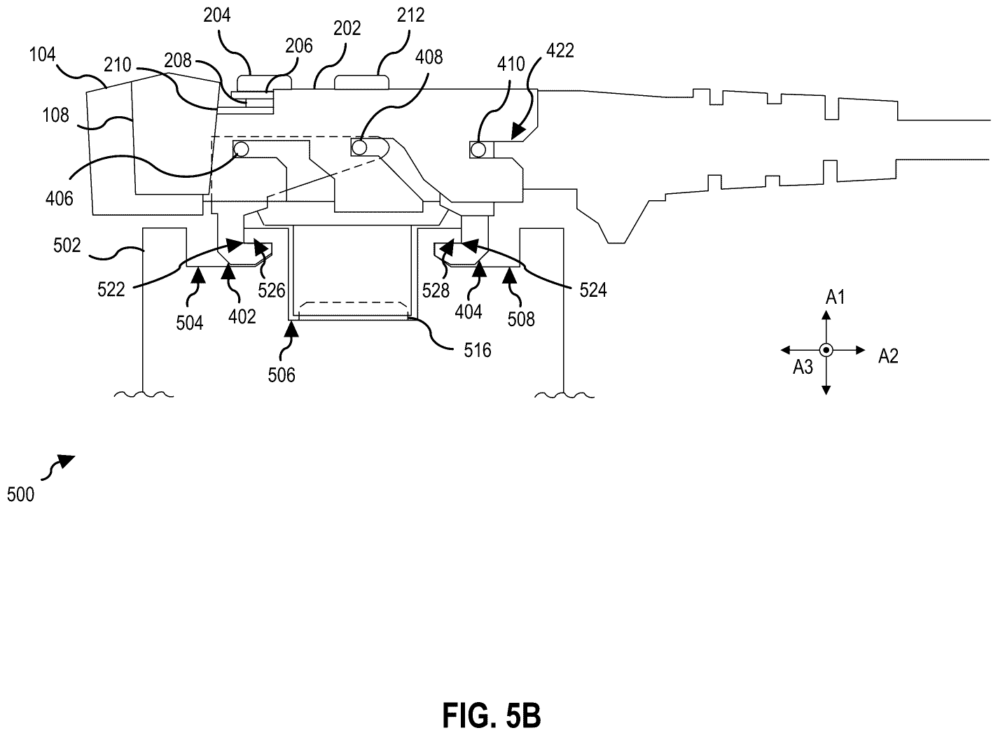

In various embodiments, and with reference to FIGS. 5A and 5B, a connector (e.g., connector 100) and a connector socket 500 are disclosed. As previously noted, the connector may be configured to switch between a locked and an unlocked state to couple a cable with an accessory such that power, data, indications, and/or other information may be exchanged with the accessory. Additionally, the accessory may comprise a connector socket configured to receive at least a connector interface and one or more latches of the connector. The connector may be configured to couple with cameras (e.g., vehicle mounted cameras, body worn cameras, etc.), computers, personal devices (e.g., mobile phones, tablets, laptops, etc.), and/or other devices. Generally, the connector may be utilized to couple a cable with an accessory such that power and/or information may be exchanged with the accessory.

In various embodiments, connector socket 500 may comprise at least a socket housing 502 that forms one or more latch sockets, an interface recess, and/or one or more surfaces that contact the connector. In particular, socket housing 502 may form a first latch socket 504, a connector interface recess 506, and a second latch socket 508. First latch socket 504 may receive first latch 402 via a first socket opening 510. Similarly, second latch socket 508 may receive second latch 404 via a second socket opening 514. A connector interface may be inserted within connector interface recess 506 via a recess opening 512. Additionally, the connector interface may couple with, form a connection with, and/or otherwise be associated with accessory interface 516.

In various embodiments, first latch socket 504 and second latch socket 508 may be formed interact with first latch 402 and second latch 404. At a first time, the connector may be in a locked state and/or an unlocked state (e.g., depicted by FIG. 5A) and unassociated with connector socket 500. At the first time, first latch 402 may be unassociated with first latch socket 504 and/or spaced from first latch socket 504 such that first latch 402 does not extend through first socket opening 510. Similarly, second latch 404 may be unassociated with second latch socket 508 and/or spaced from second latch socket 508 such that second latch 404 does not extend through first second opening 514. At a second time, the connector may be associated with connector socket 500. Association of the connector with connector socket may cause first latch 402 and second latch 404 to be inserted through first socket opening 510 and second socket opening 514. For example, the connector may be switched into the unlocked state (e.g., depicted by FIG. 5A) such that a top first latch surface 518 may fit within first latch socket 504 and/or be inserted through first socket opening 510. Similarly, and while the connector is in the unlocked state, a top second latch surface 520 may fit within second latch socket 508 and/or be inserted through second socket opening 514.

In various embodiments, the connector may be configured to prevent inadvertent insertion of first latch 402 and second latch 404 within first latch socket 504 and second latch socket 508. In particular, applying an amount of force to top first latch surface 518 and/or top second latch surface 520 may be prevented from switching the connector from a locked state to an unlocked state. For example, applying the amount of force to top first latch surface 518 and/or top second latch surface 520 may fail to rotate first latch 402 and/or second latch 404 around first latch shaft 406 and/or second latch shaft 410. Accordingly, a user input may transition the connector from the locket state to the unlocked state to enable association of the connector with connector socket 500.

In various embodiments, the connector may be transitioned between a locked state and an unlocked state to secure the connector in association with connector socket 500. In particular, and as depicted by FIG. 5A, the connector may initially be unassociated with connector socket 500. A user of the connector and connector socket 500 may cause the connector to be in the unlocked state. The user may associate the connector and connector socket 500 by inserting first latch 402 within first latch socket 504, the connector interface within connector interface recess 506, and second latch 404 within second latch socket 508. As a result, and after associating the connector with connector interface 500, the user may transition the connector from the unlocked state to the locked state. For example, and as depicted by FIG. 5B, transitioning the connector from the unlocked state to the locked state may cause first latch 402 and second latch 404 to rotate towards the connector interface. Additionally, association of the connector may be associated with top first latch surface 518 and second top latch surface 520 passing through first socket opening 510 and second socket opening 514. First top latch surface 518 and second top latch surface 520, after insertion through first socket opening 510 and second socket opening 514, may rotate towards connector interface recess 506 to transition from the unlocked state to the locked state. Further, rotation of first top latch surface 518 and second top latch surface 520 towards connector interface recess 506 may cause first latch contact surface 522 and second latch contact surface 524 to contact first socket edge 526 and second socket edge 528. First socket edge 526 may extend from a first wall of connector interface recess 506 and define a first side of first socket opening 510. Similarly, second socket edge 528 may extend from a second wall of connector interface recess 506 and define a first side of second socket opening 514.

In various embodiments, first latch 402 and second latch 404 may secure the connector in association with connector socket 500. In particular, first latch contact surface 522 may interact with first socket edge 526 to secure the connector in association with connector interface recess 506 and/or accessory interface 516. Similarly, second latch contact surface 524 may interact with second socket edge 528 to secure the connector in association with connector interface recess 506 and/or accessory interface 516. First latch contact surface 522 and second latch contact surface 524 may be configured to, in combination, prevent translation along second axis A2. First latch contact surface 522 may contact first socket edge 526 and prevent translation towards a rear connector surface such that second latch contact surface 524 remains in association with second socket edge 528 while the connector is in the locked state. Similarly, second latch contact surface 524 may contact second socket edge 528 and prevent translation towards a front connector surface such that first latch contact surface 522 remains in association with first socket edge 526 while the connector is in the locked state. As a result, first latch 402 and second latch 404 may secure the connector in association with connector socket 500 and maintain a connection between the connector interface and accessory interface 516.

In various embodiments, a connector may comprise a connector slide, one or more latches, and a connector housing. Additionally, the connector may comprise one or more handles (e.g., connector grip 106, latch grip 108, connector handle 116, etc.). The connector slide may comprise at least a slide channel and a slide track. The one or more latches may be associated with the connector slide. Further, a first latch of the one or more latches may comprise a first latch shaft, a first latch pin, and a first latch arm. The connector housing may support a connector interface and may couple with a connector cable. The connector slide may be associated with the connector housing via at least the slide track. A user input may translate the connector slide along a first axis. The slide channel may cause, based at least on the connector slide translating along the first axis, the first latch pin to translate along at least a second axis and the first latch to rotate around the first latch shaft between a locked state and an unlocked state. The user input may receive a user input via a latch grip, the user input causing the connector slide to transition between the locked state and the unlocked state. The connector slide may be disposed external to at least a top surface, a first side surface, and a second side surface. The connector slide may extend along the first axis outside of the top surface, the first side surface, and the second side surface.

In various embodiments, the first latch pin may extend from the first latch arm along a third axis through a portion of the slide channel, the third axis perpendicular to the first axis and the second axis. The slide channel may comprise a first channel surface and a second channel surface, wherein the first channel surface is associated with a first surface slope. The first channel surface may contact the first latch pin in response to the connector slide translating between a first position and a second position along the first axis, the first position associated with the locked state and the second position associated with the unlocked state. The first latch pin may translate along the second axis based at least on contact with the first channel surface and the first surface slope applying an amount of force to the first latch pin. Similarly, the second channel surface may be associated with a second surface slope. The second channel surface may contact the first latch pin in response to the connector slide translating between a second position and a first position along the first axis, the first position associated with the locked state and the second position associated with the unlocked state. The first latch pin may translate along the second axis based at least on contact with the second channel surface and the second surface slope applying an amount of force to the first latch pin. Further, the connector slide may comprise an additional slide channel and the first latch shaft extending from the first latch through the additional slide channel.

In various embodiments, the locked state of the first latch may be associated with the first latch shaft being disposed in a first shaft position within the additional slide channel and the first latch pin being disposed in a first pin position within the slide channel. Similarly, the unlocked state of the first latch may be associated with the first latch shaft being disposed in a second shaft position within the additional slide channel and the first latch pin being disposed in a second pin position within the slide channel. Additionally, translating the connector slide along the first axis may translate the first latch shaft between the first shaft position and the second shaft position and the first latch pin between the first pin position and the second pin position. It should be noted that, the first shaft position and the second shaft position may be associated with a static position of the first latch shaft relative to the connector housing. Further, the first pin position may be associated with the first latch pin being disposed in a locked position relative to the connector housing. The second pin position may be associated with the first latch pin being disposed in an unlocked position relative to the connector housing.

In various embodiments, the first latch shaft may extend through the connector housing along a third axis and may provide a rotational axis for the first latch, the third axis perpendicular to the first axis and the second axis.

In various embodiments, the first latch arm may be disposed between the connector slide and the connector housing along a first side of the connector housing. The first latch may extend from the first side of the connector housing, under a bottom side of the connector housing, and along a second side of the connector housing, the second side opposite the first side. Additionally, first latch hook may extend along at least the second axis from the first latch opposite the bottom side of the connector housing. The first latch may further comprise a second latch arm and a second latch pin, the second latch arm being disposed between the connector slide and the connector housing along the second side of connector housing.

In various embodiments, the first axis may extend through at least a front side of the connector housing and a rear side of the connector housing opposite the front side. Additionally, the second axis may extend, perpendicular to the first axis, through at least a top side of the connector housing, a rear side of the connector housing opposite the top side of the connector housing, and the slide track of the connector slide disposed proximate to the top side of the connector. Further, a third axis may extend, perpendicular to the first axis and the second axis, through at least a first side of the connector housing, a second side of the connector housing opposite the first side, a first slide side of the connector slide disposed proximate to the first side and the first latch arm, and a second slide side of the connector slide disposed proximate to the second side.

In various embodiments, a locking system may comprise a connector, a connector cable, and a connector socket. The connector may be comprised of a connector slide, one or more latches, and a connector interface. Additionally, the connector slide may translate, based at least on one or more user inputs, between a first position and a second position along a first axis. The first position may be associated with a locked state of the one or more latches and the second position may be associated with an unlocked state of the one or more latches. The one or more latches and the connector interface may extend from a bottom surface of the connector along a second axis perpendicular to the first axis. The connector cable may be in communication with the connector interface and may extend from the connector. The connector socket may comprise one or more latch sockets that receive the one or more latches based at least on the connector interface being coupled with the connector socket.

In various embodiments, the one or more latches may be disposed in one or more locked positions in the locked state. Similarly, the one or more latches may be disposed in one or more unlocked positions in the unlocked state. Additionally, the one or more latches may engage the one or more latch sockets in the locked state and may disengage from the one or more latch sockets in the unlocked state. Further, translating the one or more latches from the one or more locked positions to the one or more unlocked positions may distance the one or more latches from the connector interface. Similarly, translating the one or more latches from the one or more unlocked positions to the one or more locked positions may cause the one or more latches to approach the connector interface.

In various embodiments, the one or more latches may comprise a first latch disposed at least partially between a front surface of the connector and the connector interface along the first axis. Similarly, the one or more latches may comprise a second latch disposed at least partially between a rear surface of the connector and the connector interface along the first axis, the rear surface opposite the front surface and proximate to the connector cable. Additionally, the first latch may extend along a first surface of the connector, under the bottom surface between the front surface and the connector interface, and along a second surface of the connector. It should be noted that the second surface may be disposed opposite the first surface relative to a third axis, the third axis perpendicular to the first axis and the second axis. Similarly, the second latch may extend along the first surface, under the bottom surface between the connector interface and the rear surface, and along the second surface.

In various embodiments, the one or more latches may comprise one or more hook structures that fit within the one or more latch sockets based at least on the locked state of the connector.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosures. The scope of the disclosure is accordingly to be limited by nothing other than the appended claims and their legal equivalents, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B, and C may be present in a single embodiment; for example, A and B, A and C, B and C, or A and B and C.

Systems, methods, and apparatus are provided herein. In the detailed description herein, references to “various embodiments,” “some embodiments,” “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments. Furthermore, no element, component, or method step in the present disclosure is intended to be dedicated to the public regardless of whether the element, component, or method step is explicitly recited in the claims. No claim element is intended to invoke 35 U.S.C. 112(f) unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

1. A connector comprising:
a connector slide comprised of at least a slide channel and a slide track;
one or more latches associated with the connector slide, a first latch of the one or more latches comprised of a first latch shaft, a first latch pin, and a first latch arm;
a connector housing that supports a connector interface and couples with a connector cable, the connector slide associated with the connector housing via at least the slide track; and
wherein:
the connector slide is translated along a first axis by a user input; and
the slide channel causes, based at least on the connector slide translating along the first axis, the first latch pin to translate along at least a second axis and the first latch to rotate around the first latch shaft between a locked state and an unlocked state.

2. The connector of claim 1, wherein the connector slide receives a user input via a latch grip, the user input causing the connector slide to transition between the locked state and the unlocked state.

3. The connector of claim 1, wherein the connector slide is disposed external to at least a top surface of the connector housing, a first side surface of the connector housing, and a second side surface of the connector housing.

4. The connector of claim 1, wherein the first latch pin extends from the first latch arm along a third axis through a portion of the slide channel, the third axis perpendicular to the first axis and the second axis.

5. The connector of claim 1, wherein:
the slide channel comprises a first channel surface and a second channel surface, the first channel surface disposed opposite the second channel surface;
the first channel surface is associated with a first surface slope;
the first channel surface contacts the first latch pin in response to the connector slide translating between a first position and a second position along the first axis, the first position associated with the locked state and the second position associated with the unlocked state; and
the first latch pin is translated along the second axis based at least on contact with the first channel surface and the first surface slope applying an amount of force to the first latch pin.

6. The connector of claim 1, wherein:
the slide channel comprises a first channel surface and a second channel surface, the first channel surface disposed opposite the second channel surface;
the second channel surface is associated with a second surface slope;
the second channel surface contacts the first latch pin in response to the connector slide translating between a second position and a first position along the first axis, the first position associated with the locked state and the second position associated with the unlocked state; and
the first latch pin is translated along the second axis based at least on contact with the second channel surface and the second surface slope applying an amount of force to the first latch pin.

7. The connector of claim 1, wherein:
the locked state of the first latch is associated with the first latch shaft being disposed in a first shaft position within an additional slide channel of the connector slide and the first latch pin being disposed in a first pin position within the slide channel;
the unlocked state of the first latch is associated with the first latch shaft being disposed in a second shaft position within the additional slide channel and the first latch pin being disposed in a second pin position within the slide channel; and
translating the connector slide along the first axis translates the first latch shaft between the first shaft position and the second shaft position and the first latch pin between the first pin position and the second pin position.

8. The connector of claim 7, wherein:
the first shaft position and the second shaft position are associated with a static position of the first latch shaft relative to the connector housing;
the first pin position is associated with the first latch pin being disposed in a locked position relative to the connector housing; and
the second pin position is associated with the first latch pin being disposed in an unlocked position relative to the connector housing.

9. The connector of claim 1, wherein the first latch shaft extends through the connector housing along a third axis and provides a rotational axis for the first latch, the third axis perpendicular to the first axis and the second axis.

10. The connector of claim 1, wherein the first latch arm is disposed between the connector slide and the connector housing along a first side of the connector housing.

11. The connector of claim 10, wherein the first latch extends from the first side of the connector housing, under a bottom side of the connector housing, and along a second side of the connector housing, the second side opposite the first side.

12. The connector of claim 11, wherein a first latch hook extends along at least the second axis from the first latch.

13. The connector of claim 11, the first latch further comprising a second latch arm and a second latch pin, the second latch arm being disposed between the connector slide and the connector housing along the second side of the connector housing.

14. The connector of claim 1, wherein:
the first axis extends through at least a front side of the connector housing and a rear side of the connector housing opposite the front side;
the second axis extends, perpendicular to the first axis, through at least a top side of the connector housing, the rear side of the connector housing opposite the top side of the connector housing, and the slide track of the connector slide disposed proximate to the top side of the connector housing; and
a third axis extends, perpendicular to the first axis and the second axis, through at least a first side of the connector housing, a second side of the connector housing opposite the first side, a first slide side of the connector slide disposed proximate to the first side and the first latch arm, and a second slide side of the connector slide disposed proximate to the second side.

15. A locking system comprising:
a connector comprised of a connector slide, one or more latches, and a connector interface, wherein:
the connector slide translates, based at least on one or more user inputs, between a first position and a second position along a first axis, the first position associated with a locked state of the one or more latches and the second position associated with an unlocked state of the one or more latches; and
the one or more latches and the connector interface extend from a bottom surface of the connector along a second axis perpendicular to the first axis;
a connector cable in communication with the connector interface and extending from the connector; and
a connector socket comprising one or more latch sockets that receive the one or more latches based at least on the connector interface being coupled with the connector socket.

16. The locking system of claim 15, wherein the one or more latches are disposed in one or more locked positions in the locked state and the one or more latches are disposed in one or more unlocked positions in the unlocked state, the one or more latches engaging the one or more latch sockets in the locked state and disengaging the one or more latch sockets in the unlocked state.

17. The locking system of claim 16, wherein:
translating the one or more latches from the one or more locked positions to the one or more unlocked positions distances the one or more latches from the connector interface; and
translating the one or more latches from the one or more unlocked positions to the one or more locked positions causes the one or more latches to approach the connector interface.

18. The locking system of claim 15, the one or more latches comprising:
a first latch disposed at least partially between a front surface of the connector and the connector interface along the first axis; and
a second latch disposed at least partially between a rear surface of the connector and the connector interface along the first axis, the rear surface opposite the front surface and proximate to the connector cable.

19. The locking system of claim 18, wherein:
the first latch extends along a first surface of the connector, under the bottom surface between the front surface and the connector interface, and along a second surface of the connector, the second surface disposed opposite the first surface relative to a third axis, the third axis perpendicular to the first axis and the second axis; and
the second latch extends along the first surface, under the bottom surface between the connector interface and the rear surface, and along the second surface.

20. The locking system of claim 19, wherein the one or more latches comprise one or more hook structures that fit within the one or more latch sockets based at least on the locked state of the connector.
